(19) United States
(12) Patent Application Publication
(10) Pub. No.: US 2024/0375369 A1
(43) Pub. Date: Nov. 14, 2024

(54) FORMING PROCESS AND MANUFACTURING DEVICE OF PAPER CONTAINER BLANK

(71) Applicant: ZHEJIANG NEW DEBAO MACHINERY CO., LTD., Wenzhou (CN)

(72) Inventors: Hongan DAI, Wenzhou (CN); Ziliang PENG, Wenzhou (CN); Daojin DAI, Wenzhou (CN)

(73) Assignee: ZHEJIANG NEW DEBAO MACHINERY CO., LTD., Wenzhou (CN)

(21) Appl. No.: 18/260,252

(22) PCT Filed: Jun. 20, 2022
(86) PCT No.: PCT/CN2022/099671

§ 371 Date: Jul. 3, 2023

(30) Foreign Application Priority Data
Jan. 26, 2022 (CN) 202210091071.1

(51) Int. Cl. B31B 50/20; B31B 50/04

(52) U.S. Cl. CPC B31B 50/20; B31B 50/042

(57) ABSTRACT

The present invention relates to a forming process and a manufacturing device of a paper container blank. Two cuttings are performed on a paper roll, in which the longitudinal cutting is the first cutting, and then the cutting in the front and rear directions is the secondary cutting. In the present invention, by adopting the above process, the paper container blank can be continuously manufactured, and can be connected to a device to realize unmanned operation. The waste edge rate can be greatly reduced by the two cuttings. In addition, the device for implementing the process of the present invention includes a secondary cutting mechanism. Specifically, through the setting of the die in the cutting process, the first longitudinal cutting can first form left and right side edges of all the blanks, the front and rear parts are all connected together, and the adjacent two blanks do not have a waste edge, which is very ingenious in design. Moreover, with the cooperation of the secondary cutting, the finished product is formed after the secondary cutting. The formed product blank can be directly sent to a paper cup machine or a paper bowl machine, so that the unmanned work can be realized to a certain extent when the device is turned on.

### CROSS-REFERENCE TO THE RELATED APPLICATIONS

This application is the national phase entry of International Application No. PCT/CN2022/099671, filed on Jun. 20, 2022, which is based upon and claims priority to Chinese Patent Application No. 202210091071.1, both filed on Jan. 26, 2022, the entire contents of which are incorporated herein by reference.

### TECHNICAL FIELD

The present invention relates to a forming process and a manufacturing device of a blank used for a paper cup machine or a paper bowl machine.

### BACKGROUND

In the prior art, blank forming is achieved by cutting a paper roll using a die-cutting machine or cutting paper sheets using the die-cutting machine, and then manually putting the stacked blanks into a material bin of a paper cup machine. The blanks are formed at one time, stacked and taken away. Because the die-cutting machine is not connected to the paper cup machine, an industrialized unmanned assembly-line manufacture cannot be realized. Further, labor costs are increased and manufacturing efficiency of paper cups is restricted.

In addition, for the cutting of paper rolls or paper sheets, since the blank is in an annulus-sector shape, the two sides of the annulus-sector shape are symmetrical, and the inner and outer arcs thereof are not identical. In order to minimize the waste of paper, two adjacent blanks are set upside down so that the beveled sides of the annulus-sector shape are matched. However, except for the beveled sides, the inner and outer arcs of the blank are curved, resulting in the inevitable waste as shown in FIGS. 1-3. For paper container manufacturers, waste increases the cost of paper containers, which is not conducive to market competition. Moreover, in the prior art, the connection bar is added during the processing of the paper roll, as shown in FIGS. 1-3, which increases the waste edge and the cost. Further, the waste needs to be removed, and then, the blanks are manually put into the material bin of the paper cup machine, in which about 1300 pieces are put once every 10 minutes. The manual operation is very tedious.

### SUMMARY

In view of this, the technical problem solved by the present invention is to provide a forming process and a manufacturing device of a paper container blank, which does not cause waste and can greatly improve the manufacturing efficiency. In order to realize the objective, the present invention is realized by the following technical solutions:

A forming process of a paper container blank includes:
A: putting a rolled large-format paper roll on a feeding rack;
B: cutting left and right side edges of the paper roll with a cutting tool along a conveying direction, where the cutting here is a first cutting, and at least one side is zigzag after the first cutting;
C: rolling a continuous blank obtained after the left and right side edges are cut to form a small-format paper roll, or directly entering a next cutting process;
D: cutting the small-format paper roll with a cutting tool in front and rear directions, where the cutting here is a secondary cutting; and
E: allowing a cut paper from step D to form the paper container blank.

Preferably, the cutting tool in step B is selected from a platen die cutting machine, or a rotary die cutting machine, or a laser cutting machine.

Preferably, the cutting tool in step D is selected from a platen die cutting machine, or a rotary die cutting machine, or a laser cutting machine, or a punching cutting machine.

Preferably, in step D, a waste edge of the paper container blank after being cut in the front and rear directions is removed.

Preferably, in step C, the rolling adopts upper and lower stagger rolling.

Most preferably, step B further includes cutting waste edges on both sides of the large-format paper.

A manufacturing device of a paper container blank for implementing the above forming process includes a large-format paper roll feeding rack, and a cutting mechanism for cutting the large-format paper roll into a small-unit paper roll in the conveying direction. A small-unit paper roll receiving rack is arranged at the rear end of the cutting mechanism, or a next cutting mechanism is directly arranged at the rear end of the cutting mechanism.

Preferably, the manufacturing device of the paper container blank further includes a small-unit paper roll feeding rack, a mechanism for cutting the small-unit paper roll in the front and rear directions, and a blank collection bin.

Preferably, at least two rolling shafts are arranged on the small-unit paper roll receiving rack and distributed up and down, and adjacent units of the small-unit paper roll after being cut are collected on the two rolling shafts respectively.

Preferably, the collection bin is a blank paper feeding bin of a paper cup machine or a paper bowl machine.

Preferably, the mechanism for cutting the small-unit paper roll in the front and rear directions further includes a small-area waste removal device.

Most preferably, the cutting mechanism is a platen die cutting machine, or a punching cutting machine, or a rotary die cutting machine, or a laser cutting machine.

Preferably, the waste removal device is a die preset with the same size as a waste edge.

Preferably, the die includes a cutter adjacent to an edge of a blank cutter, and two ends of the cutter are connected to the edge of the blank cutter.

In the present invention, by adopting the above process, the paper container blank can be continuously manufactured, and can be connected to a device to realize unmanned operation. Moreover, because of the waste edge cutting, the waste edge rate can be greatly reduced by two cuttings.

In addition, the device for implementing the process of the present invention includes a secondary cutting mechanism. Specifically, through the setting of the die in the cutting process, the first longitudinal cutting can first form left and right side edges of all the blanks, the front and rear parts are all connected together, and the adjacent two blanks do not have a waste edge, which is very ingenious in design. Moreover, with the cooperation of the secondary cutting, the finished product is formed after the secondary cutting. The formed product blank can be directly sent to a paper cup machine or a paper bowl machine, so that the unmanned work can be realized to a certain extent when the device is turned on. In the present invention, the operator only needs to manually unroll the paper roll, and the unrolling is performed once every 2 hours, which reduces manual operation, and greatly improves the manufacturing efficiency of the paper cup.

### BRIEF DESCRIPTION OF THE DRAWINGS

FIG. 1 shows a direct punching forming method of a paper roll blank in the prior art.

FIG. 2 shows the prior art in which the paper roll is first cut into paper sheets and then punched and formed.

FIG. 3 shows the prior art in which the paper sheets are punched and fed.

FIG. 4 shows a first cutting manner in which two sides are zigzag according to the present invention.

FIG. 5 shows a secondary cutting manner in which two sides are zigzag according to the present invention.

FIG. 6 shows a first cutting mechanism according to the present invention.

FIG. 7 shows a secondary cutting mechanism according to the present invention.

FIG. 8 shows a first cutting manner in which a single side is zigzag according to the present invention.

FIG. 9 shows a secondary cutting manner in which a single side is zigzag according to the present invention.

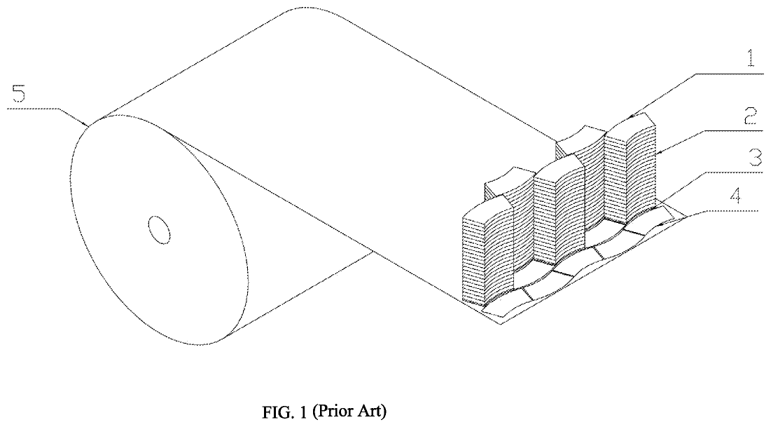

In FIGS. 1-3: 1. manual removal after stacking; 2. stacking; 3. punching die; 4. waste; 5. paper roll; 6. flat cutting; 7. paper sheets;

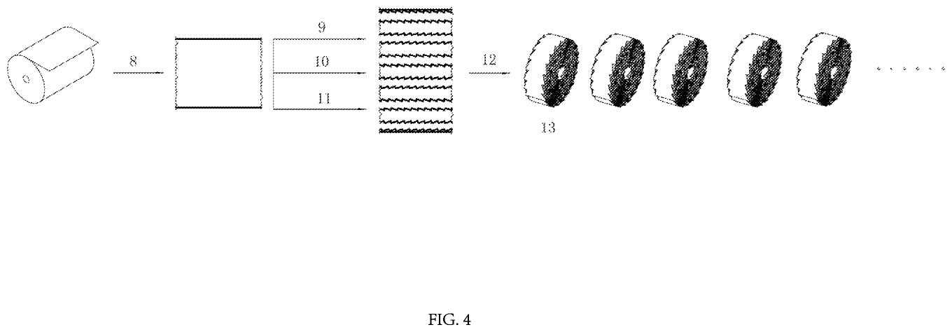

In FIGS. 4-9: 8. unrolling; 9. platen die cutting; 10. laser cutting; 11. rotary die cutting; 12. rolling; 13. paper roll; 14. unrolling; 15. punching; 16. waste discharging; 17. manufacturing a cup by a paper cup mechanism; 18. directly connecting; and 19. flat paper.

### DETAILED DESCRIPTION OF THE EMBODIMENTS

The present invention is further described in detail below in conjunction with the drawings and embodiments.

### Embodiment

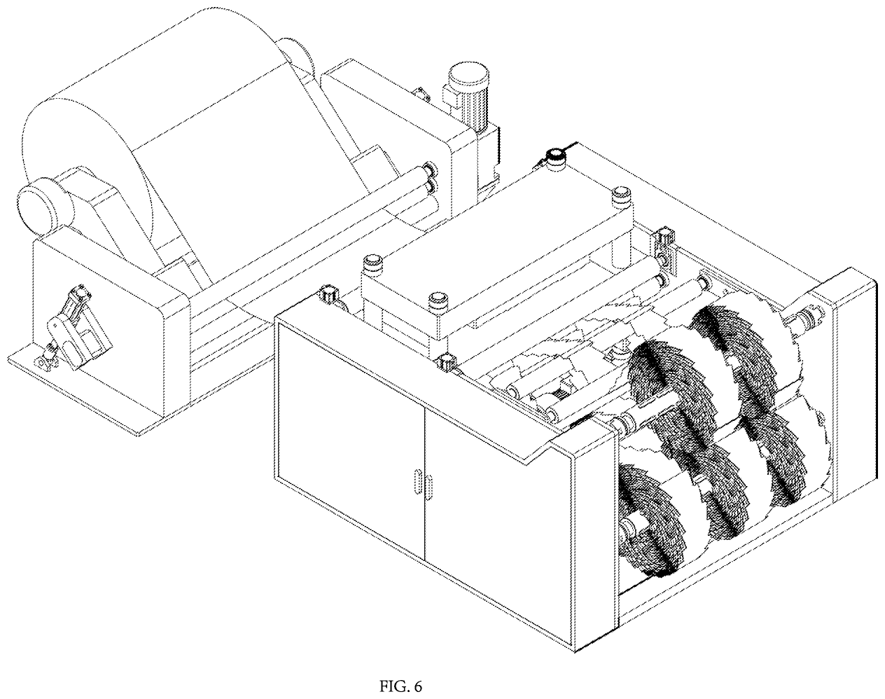

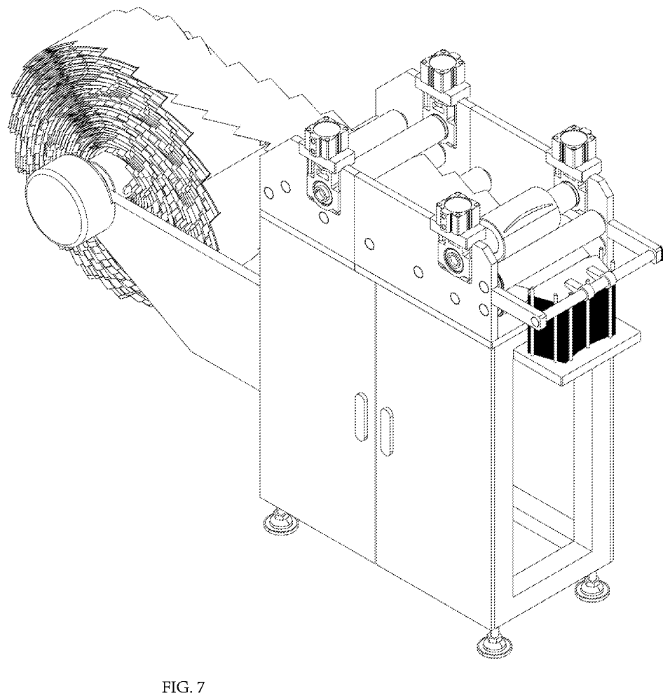

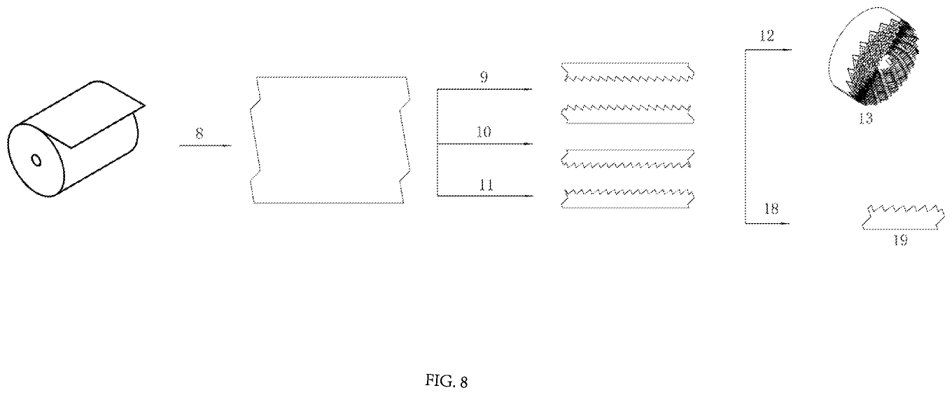

The technological process of the present invention is shown in the drawings, and is further described in detail in conjunction with the drawings. A forming process of a paper container blank includes the following steps: the present invention is aimed at processing paper rolls.
A: a rolled large-format paper roll is put on a feeding rack by hand or by a manipulator.
B: a first cutting is performed, as shown in FIG. 6, that is, the left and right side edges of the rolled paper are cut with a cutting tool along a conveying direction, here the cutting is very important to longitudinally cut the large-format paper into a strip, so that the side edges are formed, and the front and rear ends are connected in a conjoined shape. This is first forming of the blank. There are a plurality of cutting manners for side edge forming, for example, FIG. 4 shows symmetrical left and right side edges, and FIG. 8 shows asymmetrical left and right side edges. But either way, at least one side is zigzag, so that the direct forming of the secondary processing in FIG. 7 can be realized.
C: the continuous blank obtained after the left and right side edges are cut is rolled to form a small-format paper roll, and the adjacent sides of the small-format paper roll are distributed in parallel with each other. In this way, all paper is utilized and there is no waste of the paper between two blanks. Alternatively, according to the cup shape, one side can also be a straight side, and the other side is a zigzag side. Moreover, according to the needs of the user, the continuous blank obtained after the left and right side edges are cut can also be conveyed directly to the next cutting position without being rolled, for example, the blank is directly conveyed to the blank bin of the paper cup machine. In this way, the automatic unmanned concept can be implemented.
D: the small-format paper roll enters a feeding rack, or directly enters a next cutting position through a guide roller, where the placement can be understood as manually putting the small-format paper roll on another feeding rack, or the outputted small-format paper roll is guided directly by the guide roller, and the guide roller here serves as the feeding rack. The manual placement is not automatic, while the direct rolling and placement is equivalent to automatic work. Then, the small-format paper roll is cut by the cutting tool in the front and rear directions, which is the secondary forming, namely the final forming, and the conjoined part of the front and rear ends is cut into a unit sheet-shaped blank.
E: the cut paper from step D forms the paper container blank.

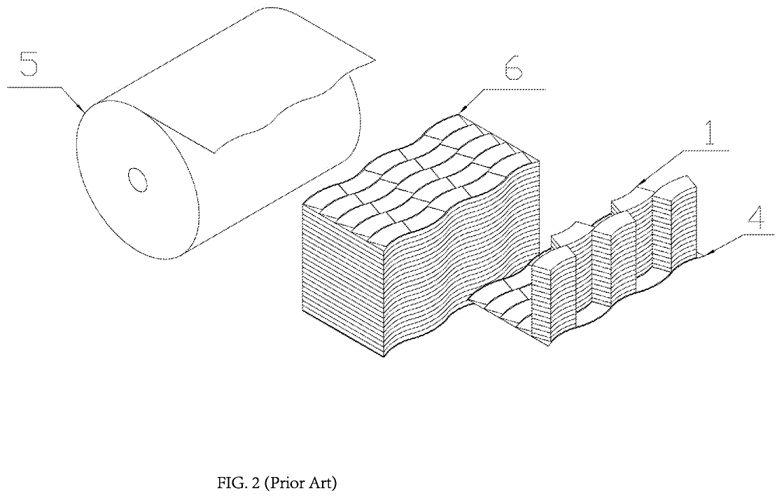

In the process of the present invention, there are two forming processes of the paper roll. In the first forming process, the side cutting is performed to form a strip, the strip is rolled, and then the strip is unrolled as the beginning of the secondary forming process. After the secondary forming, the strip can be stacked or the strip can be directly connected to a paper cup machine or a paper bowl machine, so that the formed blank directly falls into the bin of the paper cup machine or the paper bowl machine to realize automatic work. In this way, only the large-format material roll needs to be replaced, and the unmanned work can be realized to a certain extent when the device is turned on. Moreover, through the secondary cutting manner, it is fully realized that the paper is used except for the waste edges on both sides and a little bit of arc waste edge in the middle. Further, the blank with asymmetric edges in FIG. 2 does not even have the arc waste edge in the middle.

In the conception of the present invention, the cutting tool in step B can be selected from a platen die cutting machine, or a rotary die cutting machine, or a laser cutting machine. The selection of the cutting tool is not the focus of the present invention, and the commercial cutting device can be fully used for replacement. However, the arrangement of a cutter used in the cutting tool is very important for realizing the first cutting. The arrangement of the cutter used in the cutting tool, such as a sawtooth shape, namely one-side sawtooth shape or double-side sawtooth shape, is never disclosed in the prior. It is precisely because of the cutter of this shape that the left and right blanks can be divided into two pieces, all of the paper roll can be utilized. The sawtooth angle can be calculated according to the shape and size of the paper cup. This calculation is not the key point, but there must exist an angle.

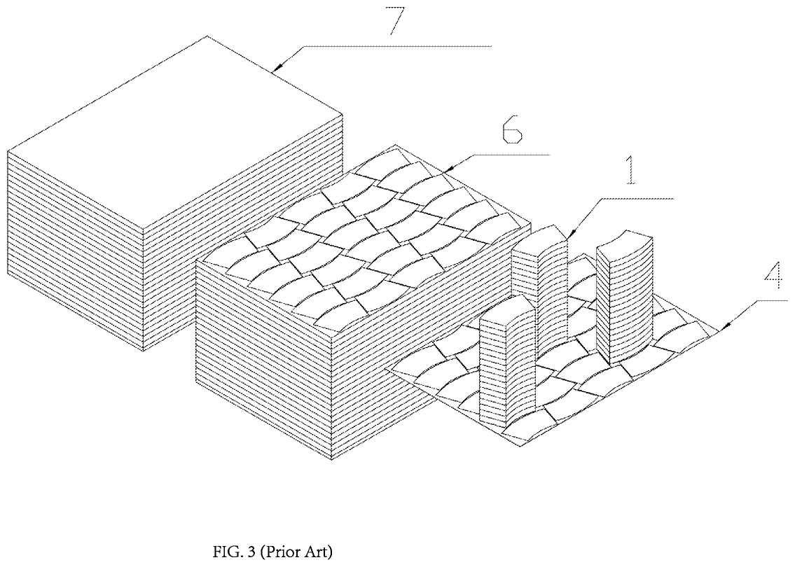

The cutting tool in step D can be selected from a platen die cutting machine, or a rotary die cutting machine, or a laser cutting machine, or a punching cutting machine. The cutting here is the same as above, the device is all sold in the market, and the main focus is the radian of the cutter. The radian of the device need to meet the requirement for the two forming process. However, since the paper cup is generally tapered from top to bottom, the upper radian is large, and the lower radian is small. Since the upper and lower blanks are connected end-to-end, a little waste edge is generated because of the different radians. Therefore, a small cutter matched with the shape and size of the waste edge is connected around the cut-off tool. In this way, the secondary cutting is done in one step. Moreover, the asymmetrical sides as shown in FIG. 3 do not need to remove the small waste edge.

It is necessary to remove the waste edge of the paper container blank after being cut in the front and rear directions. Here, the waste edge can fall off by itself, or be sucked away by a tool.

In step C, the rolling adopts upper and lower stagger rolling, and the adjacent strip paper can be separated through stagger rolling without abutting each other.

Step B further includes cutting the waste edges on both sides of the large-format paper. After the waste edges of the large-format paper are cut, the remaining paper is fully utilized to improve the paper utilization rate and reduce the cost to a certain extent.

The present invention also relates to a manufacturing device of a paper container blank for realizing the process in the above embodiment. The manufacturing device includes a large-format paper roll feeding rack. The feeding rack is provided with a feeding roll. The manufacturing device further includes a cutting mechanism for cutting the large-format paper roll into a small-unit strip paper roll in the conveying direction. The cutting mechanism belongs to the prior art. However, the structure of a cutter arranged in the cutting mechanism is very critical and does not belong to the prior art, and the cutter is specially designed to realize one-time cutting. The single die is changed into a continuous die, and the front and rear ends are connected, so that the cut paper pieces are also connected end-to-end. A small-unit paper roll receiving rack is arranged at the rear end of the cutting mechanism. This is the first cutting. After the cutting is finished, the next cutting link is performed. The cut paper can be rolled, or directly enter the secondary cutting position without rolling. The secondary cutting is the cutting in the front and rear directions. The device in the present invention is mainly to carry out the work station layout of the secondary cutting of the paper roll. Two cutting mechanisms are required in both cases that the cut paper directly enters the secondary cutting mechanism after the first cutting mechanism, or the cut paper is rolled after the first cutting mechanism, unrolled and then cut through the secondary cutting mechanism.

In the case that the cut paper does not directly enter the secondary cutting position, the manufacturing device further includes a small-unit paper roll feeding rack, a mechanism for cutting the small-unit paper roll in the front and rear directions, and a blank collection bin.

In the case that the cut paper is rolled, at least two rolling shafts are arranged on the small-unit paper roll receiving rack and distributed up and down. The adjacent units of the small-unit paper roll after being cut are collected on the two rolling shafts respectively, and the stagger rolling can realize rolling and stripping at the same time.

In order to realize the automatic work, the collection bin can be the blank paper feeding bin of the paper cup machine or the paper bowl machine.

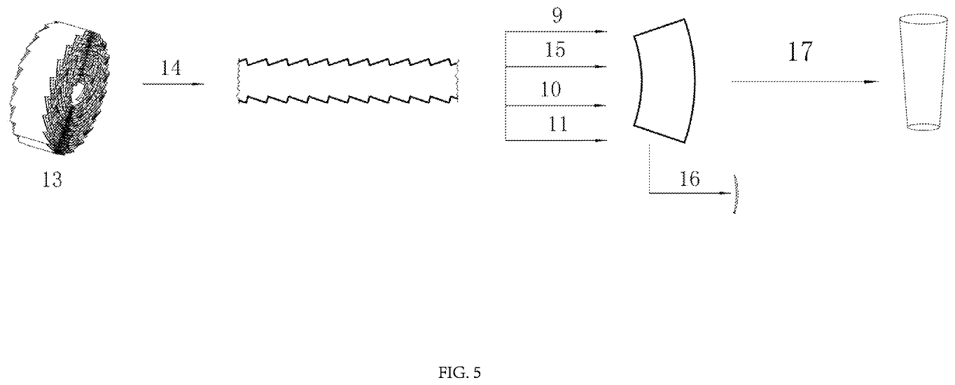

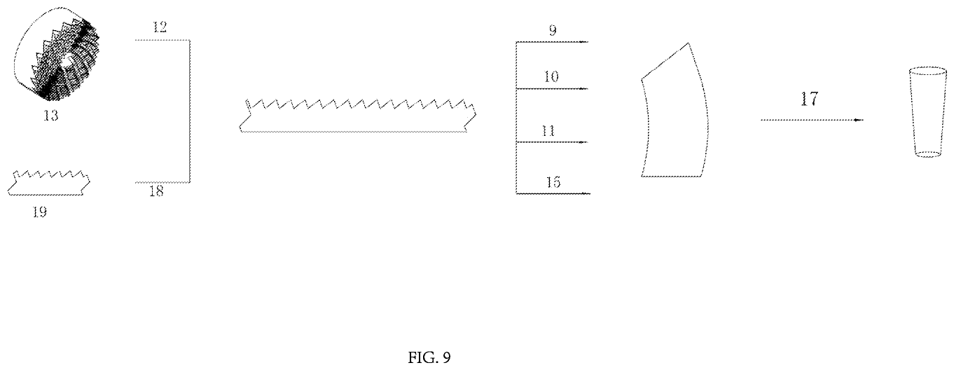

Secondary cutting can be one cutting, so that two sides are directly used without any waste. The layout in FIG. 9 is set according to the specification of the paper cup. Alternatively, as shown in FIG. 5, since there exists a small waste edge due to different front and rear radians, the mechanism for cutting the small-unit paper roll in the front and rear directions further includes a small-area waste removal device. The waste removal device is a die preset with the same size as the waste edge. The die includes a cutter adjacent to an edge of a blank cutter, and two ends of the cutter are connected to the edge of the blank cutter.

The cutting mechanism is a platen die cutting machine, or a punching cutting machine, or a rotary die cutting machine, or a laser cutting machine.

In conclusion, the above only describes the preferred embodiments of the present invention, and all equal changes and modifications made in accordance with the scope of the patent application for the present invention shall fall within the scope of the present invention.

What is claimed is:

1. A forming process of a paper container blank, comprising:
A: putting a rolled large-format paper roll on a feeding rack;
B: cutting left and right side edges of the rolled large-format paper roll with a first cutting tool along a conveying direction, wherein the cutting here is a first cutting, and at least one side is zigzag after the first cutting;
C: rolling a continuous blank obtained after the left and right side edges are cut to form a small-format paper roll, or directly entering a next cutting process;
D: cutting the small-format paper roll with a second cutting tool in front and rear directions, wherein the cutting here is a secondary cutting; and
E: allowing a cut paper from step D to form the paper container blank.

2. The forming process of the paper container blank according to claim 1, wherein the first cutting tool in step B is selected from a platen die cutting machine, or a rotary die cutting machine, or a laser cutting machine.

3. The forming process of the paper container blank according to claim 1, wherein the second cutting tool in step D is selected from a platen die cutting machine, or a rotary die cutting machine, or a laser cutting machine, or a punching cutting machine.

4. The forming process of the paper container blank according to claim 3, wherein in step D, a waste edge of the paper container blank after being cut in the front and rear directions is removed.

5. The forming process of the paper container blank according to claim 3, wherein in step C, the rolling adopts upper and lower stagger rolling.

6. The forming process of the paper container blank according to claim 1, wherein step B further comprises cutting waste edges on both sides of the rolled large-format paper roll.

7. A manufacturing device of a paper container blank for implementing the forming process of the paper container blank according to claim 1, comprising:
a large-format paper roll feeding rack, and
a cutting mechanism for cutting the large-format paper roll into a small-unit paper roll in the conveying direction,
wherein a small-unit paper roll receiving rack is arranged at a rear end of the cutting mechanism, or a next cutting mechanism is directly arranged at the rear end of the cutting mechanism.

8. The manufacturing device of the paper container blank according to claim 7, further comprising a small-unit paper roll feeding rack, a mechanism for cutting the small-unit paper roll in the front and rear directions, and a blank collection bin.

9. The manufacturing device of the paper container blank according to claim 7, wherein at least two rolling shafts are arranged on the small-unit paper roll receiving rack and distributed up and down, and adjacent units of the small-unit paper roll after being cut are collected on the at least two rolling shafts respectively.

10. The manufacturing device of the paper container blank according to claim 8, wherein the blank collection bin is a blank paper feeding bin of a paper cup machine or a blank paper feeding bin of a paper bowl machine.

11. The manufacturing device of the paper container blank according to claim 8, wherein the mechanism for cutting the small-unit paper roll in the front and rear directions further comprises a small-area waste removal device.

12. The manufacturing device of the paper container blank according to claim 7, wherein the cutting mechanism is a platen die cutting machine, or a punching cutting machine, or a rotary die cutting machine, or a laser cutting machine.

13. The manufacturing device of the paper container blank according to claim 11, wherein the small-area waste removal device is a die preset with a same size as a waste edge.

14. The manufacturing device of the paper container blank according to claim 13, wherein the die comprises a cutter adjacent to an edge of a blank cutter, and two ends of the cutter are connected to the edge of the blank cutter.

15. The manufacturing device of the paper container blank according to claim 7, wherein the first cutting tool in step B is selected from a platen die cutting machine, or a rotary die cutting machine, or a laser cutting machine.

16. The manufacturing device of the paper container blank according to claim 7, wherein the second cutting tool in step D is selected from a platen die cutting machine, or a rotary die cutting machine, or a laser cutting machine, or a punching cutting machine.

17. The manufacturing device of the paper container blank according to claim 16, wherein in step D, a waste edge of the paper container blank after being cut in the front and rear directions is removed.

18. The manufacturing device of the paper container blank according to claim 16, wherein in step C, the rolling adopts upper and lower stagger rolling.

19. The manufacturing device of the paper container blank according to claim 7, wherein step B further comprises cutting waste edges on both sides of the rolled large-format paper roll.

20. The manufacturing device of the paper container blank according to claim 8, wherein the cutting mechanism is a platen die cutting machine, or a punching cutting machine, or a rotary die cutting machine, or a laser cutting machine.
